(19) United States
(12) Patent Application Publication
(10) Pub. No.: US 2023/0132694 A1
(43) Pub. Date: May 4, 2023

(54) METHODS AND APPARATUSES FOR OXIDANT CONCENTRATION CONTROL

(71) Applicant: Aqua Research, Inc., Albuquerque, NM (US)

(72) Inventor: Rodney E. Herrington, Albuquerque, NM (US)

(21) Appl. No.: 18/146,568

(22) Filed: Dec. 27, 2022

Related U.S. Application Data
(63) Continuation of application No. 16/958,543, filed on Jun. 26, 2020, now abandoned.
(60) Provisional application No. 62/592,276, filed on Nov. 29, 2017.

(51) Int. Cl. C02F 1/467; C02F 1/461

(52) U.S. Cl. CPC C02F 1/467; C02F 1/46104; C02F 2201/46145; C02F 2201/4618; C02F 2209/005; C02F 2303/04

(57) ABSTRACT

Methods and apparatus for controlling electrolysis in an electrolytic cell in order to maintain constant concentration of the disinfectant irrespective of the rate of electrolyte concentration or oxidant production in the electrolytic cell.

### TECHNICAL FIELD

The present invention relates to control of oxidant concentration in two-phase flow in electrolytic cells for production of oxidants.

### BACKGROUND ART

The following discussion refers to a number of publications and references. Discussion of such publications herein is given to facilitate understanding of the background of scientific principles related to the present invention and is not to be construed as an admission that such publications are prior art for patentability determination purposes. Each of such publications is incorporated herein by reference.

Electrolytic technology utilizing dimensionally stable anodes (DSA) has been used for years for the production of chlorine and other mixed-oxidant solutions. Dimensionally stable anodes are described in U.S. Pat. No. 3,234,110 to Beer, entitled “Electrode and Method of Making Same,” whereby a noble metal coating is applied over a titanium substrate.

An example of an electrolytic cell with membranes is described in U.S. Patent RE 32,077 to deNora et al., entitled “Electrode Cell with Membrane and Method for Making Same,” whereby a circular dimensionally stable anode is utilized with a membrane wrapped around the anode, and a cathode concentrically located around the anode/membrane assembly.

An electrolytic cell with dimensionally stable anodes without membranes is described in U.S. Pat. No. 4,761,208 to Gram, et al., entitled “Electrolytic Method and Cell for Sterilizing Water.”

Commercial electrolytic cells that have been used routinely for oxidant production utilize a flow-through configuration that are optionally under adequate pressure to create flow through the electrolytic device. Examples of cells of this configuration are described in U.S. Pat. No. 6,309,523 to Prasnikar et al., entitled “Electrode and Electrolytic Cell Containing Same,” and U.S. Pat. No. 5,385,711 to Baker et al., entitled “Electrolytic Cell for Generating Sterilization Solutions Having Increased Ozone Content”.

Typically one of two control schemes is used in commercial on-site chlorine generation systems using continuous flow through systems. These schemes are utilized in order to optimize operational performance in terms of operating cost while maintaining a fixed rate of oxidant production.

Process Solutions Inc. (PSI), Campbell, Calif. utilizes a constant feed brine and fluid stream so that the electrolyte concentration entering the cell is constant, but then controls the voltage to maintain oxidant concentration. As the electrodes become contaminated, primarily through calcium carbonate scale formation on the cathode electrode, the voltage is increased to overcome the increase in electrical resistance in the system. In this way, electrolyte conversion efficiency is maintained at the expense of increased power consumption.

Typical control schemes that are used in MIOX Corporation electrolytic on-site generators are described in U.S. Pat. No. 7,922,890 to Sanchez, et al. entitled “Low Maintenance On-Site Generator”. This control scheme utilizes a process that maintains an accurate and steady water flow rate entering the electrolytic cell. The voltage on the system is fixed. Fully saturated brine from a variable speed brine pump enters the water fluid stream, hence an electrolyte, that enters the cell. A fixed amperage in the cell generates oxidant at a fixed concentration. If the amperage on the cell is low, the control system tells the brine pump to speed up which increases the brine concentration of the electrolyte entering the cell and consequently increases the conductivity of the electrolyte and the amperage draw from the power supply to the cell. In this scheme, the electrolyte concentration can vary in order to maintain the correct amperage in the cell. If the amperage is maintained with the flow and applied voltage constant, then the oxidant concentration can be maintained constant. While power conversion efficiency is maintained, electrolyte conversion efficiency can vary. A similar product was the so-called Brine Pump System, or BPS. The BPS was housed in a hard plastic case and included a brine pump, power supply, and electrolytic cell. However, this system utilized a constant speed electrolyte pump. This system required the operator to mix the salt and water correctly in order make the electrolyte thereby allowing the oxidant concentration to come out correctly. There was no control scheme to maintain constant oxidant concentration.

### SUMMARY OF INVENTION

Embodiments of the present invention can control the concentration of the disinfectant produced in an electrolytic system for the production of disinfectants. In contrast to other control schemes, the rate of oxidant production and operational efficiency are not the key parameters. Embodiments of the present invention control the concentration of oxidants produced in the cell. By controlling the correct oxidant concentration, dosing by the user is consistent. In low income settings, the salt and water that are mixed to make the electrolyte can be mixed manually, and thus might be mixed inaccurately. Embodiments of the present invention can compensate for human errors when making the electrolyte solution by mixing salt and water together. In some embodiments of the present invention, neither the electrolyte conversion efficiency nor the power conversion efficiency are key parameters. With low electrolyte brine concentration, the rate of oxidant production is low. This is because the electrical conductivity of the solution is low and will therefore draw lower amperage from the power source. Embodiments of the present invention reduce the electrolyte flow rate to maintain oxidant concentration by increasing the residence time of the electrolyte in the cell, thereby converting more brine to oxidant and increasing the concentration of the oxidant. Conversely if the electrolyte concentration is high, the rate of oxidant production is high and the control scheme increases the electrolyte flow rate to maintain the correct concentration of oxidant, nominally 5,000 mg/l concentration.

Advantages of the present invention include improved stability of the concentration of disinfectants regardless of the electrolyte feed concentration, applied voltage, or flow through the electrolytic cell, thereby making the system simpler to operate in settings where the operator is poorly trained, and where inaccuracies can be compensated for in systems used in low educational environments, by the military, in disaster relief settings, and other applications where simplicity of operation and fault tolerance is important. In this configuration, operational efficiency is balanced against fault tolerance. In these applications, consistent oxidant concentration is important to ensure consistent oxidant dosing by untrained operators. According to the Center for Disease Control and Prevention (CDC) and the World Health Organization (WHO) the appropriate dose to clean medical surfaces is 5,000 milligrams per liter (mg/l), or parts per million (ppm). As an example, this is the recommended dose used to sanitize medical areas and surfaces, human remains, and other surfaces actively exposed to Ebola in outbreaks such as those that occurred in Africa around 2015. The control scheme described herein produces a disinfectant with this nominal concentration. The control scheme can be configured to make consistent oxidant of any practical concentration, typically less than 10,000 milligrams per liter.

A concentration of 500 ppm is typically recommended for people in household settings to clean their hands and other applications for normal disinfection when threats like active Ebola reside in the environment. At 500 ppm, it is easy to instruct the user to add 10 parts of water to the neat disinfectant (at 5,000 ppm) to achieve a disinfectant of about 500 ppm concentration. For treating water that is intended for human consumption (i.e. potable water), it is easy to instruct a user to add one part of disinfectant via a measuring device (such as a teaspoon or other measuring container) to add one part of neat disinfectant (at 5,000 mg/l) to 1000 parts of water. In this case, one milliliter (ml) of disinfectant to each liter of water to be treated. The result is a 5 mg/l dose of disinfectant to the water. This is the typical dose utilized by the US Military for field treated water. In normal surface or ground water to be treated to become potable water, a 5 mg/l dose will render most water safe to drink. The US Environmental Protection Agency (USEPA) maximum recommended residual value in municipally treated water is 4.0 mg/l. In disaster relief situations or low-income settings where the safety of the water is paramount, a dose of 5 mg/l will typically result in a chlorine residual value of less than 4.0 mg/l due to oxidant demanding substances in the raw water. At 5.0 mg/l dose, the majority of waters will have a positive chlorine residual value which helps ensure the water is safe to drink.

Other advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a view of the flow diagram of the system.

FIG. 2 is a view of a chart that shows concentration over time at 12, 15, and 18 grams per liter brine concentrations.

### DESCRIPTION OF EMBODIMENTS AND INDUSTRIAL APPLICABILITY

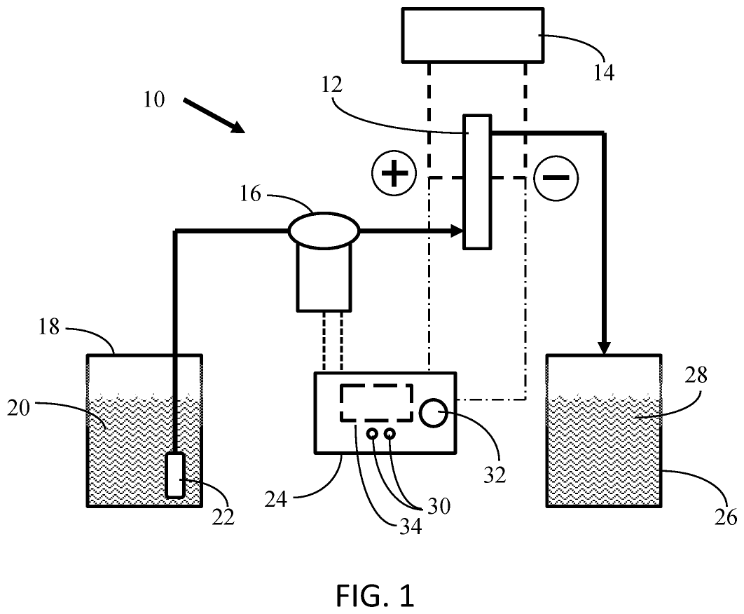

FIG. 1 is an example embodiment of a system according to the present invention. System 10 comprises electrolytic cell 12, electrolyte pump 16, power supply 14, control circuit 24, electrolyte tank 18 and oxidant tank 26. Electrolyte 20 comprises water and a halogen salt, commonly sodium chloride, dissolved in the water. In an example embodiment, the electrolyte concentration is approximately 15 grams per liter (g/l) of sodium chloride and is typically made manually by measuring a correct amount of salt (sodium chloride) in a known amount of water. However, the concentration of the electrolyte can vary widely from less than 10 g/l to greater than 22 g/l depending on how accurate the operator mixes the salt into the water. Power supply 20 can obtain its power from conventional line power such as 110/220 VAC single phase source of electricity, or from other power sources such as batteries, generators, and solar cells. Output power can be, as an example, nominally 12 volts direct current (VDC) and is supplied to control panel 24. Control panel 24 can also comprise direct current power terminals 30. To these power terminals 30 can be connected a direct current source of power such as a car battery, solar panel, or other source of direct current power. Control circuit 34 and power to electrolyte pump 16 can be provided within control panel 24. Control panel 24 can also incorporates a main power switch 32.

Upon activation of main power switch 32, electrolyte pump 16 can be activated by control circuit 34. Electrolyte pump 16 is, for example, a positive displacement pump such as a peristaltic pump with a variable speed motor which can be a DC motor or stepper motor or other type of variable speed motor. As electrolyte pump 16 begins to operate, electrolyte 20 is drawn through optional filter 22, which helps remove contaminants or undissolved salt and can help extend the life of electrolyte pump 16. Electrolyte 20 then proceeds through electrolyte pump 16 and enters electrolytic cell 12. Power from control circuit 34 within control panel 24 is applied to electrolytic cell 12. The electrolyte within cell 12 is converted to oxidant 28 which is transported to oxidant tank 26. The conversion of electrolyte 20 to oxidant 28 is a well-known chemical reaction that produces a strong disinfecting solution. Oxidant 28 can be used to disinfect contaminated sources of fresh water to make it potable for human consumption, can be used to disinfect surfaces in medical settings, or other applications where a strong disinfectant solution is needed. It is often important, however, that the concentration of the disinfectant be consistent and stable in order that the proper dose of disinfectant is applied to the application in question.

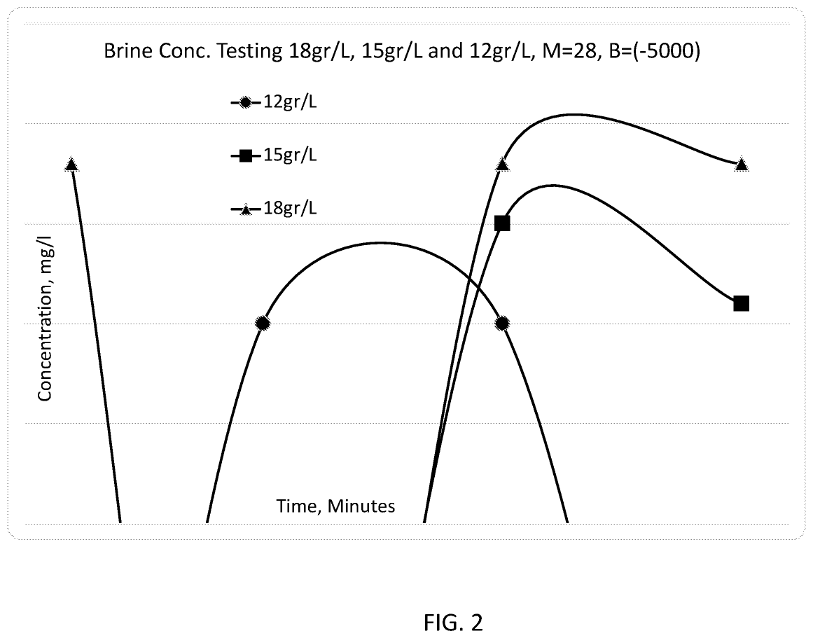

In an example embodiment of the present invention, control panel 24 comprises control circuit 34 that measures the electrical current that is applied to electrolytic cell 12. Current and flow rate of electrolyte solution 20 determine the concentration of disinfectant solution 28 flowing from electrolytic cell 12. In the case of positive displacement electrolyte pump 16 the flow rate is precisely controlled by the speed of electrolyte pump 16. In an example embodiment, the salinity, or brine concentration, of electrolyte solution 20 has already been determined by the operator when salt and water are mixed by the operator. Through the amperage applied to electrolytic cell 12 and the speed of electrolyte pump 16 the concentration of disinfecting solution 28 can be determined. An example of this data is presented in FIG. 2. FIG. 2 shows the concentration of oxidant 28 for three different brine concentrations where the speed of electrolyte pump 16 has been controlled by controller 34. As the data shows, the concentration of the oxidant is held in the 5,000 to 6,000 mg/l range irrespective of the saline concentration of the electrolyte. As the conductivity of the electrolyte goes up as measured by the amperage draw in cell 12, the speed of electrolyte pump 16 increases to increase the flow rate of the oxidant in the cell. As the amperage goes down, the flow rate is reduced by electrolyte pump 16 so that the final concentration remains fixed at approximately 5,000 mg/l. The resulting equation is:

Concentration, mg/l=(Production rate, mg/min)/(Flow rate, l/min)

From inspection of the above equation, in order to maintain the same oxidant concentration, the flow rate of the electrolyte must go up as the oxidant production rate goes up, and vice versa. The software logic in control board 34 is programmed to monitor the amperage in cell 12, and increase or decrease the electrolyte flow rate accordingly by controlling the speed of electrolyte pump 16.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all patents and publications cited above are hereby incorporated by reference.

We claim:

1. An apparatus for the production of disinfectant, comprising:
(a) an electrolyte pump having an input port in fluid communication with a source of electrolyte and an output port;
(b) an electrolytic cell having an input port in fluid communication with the output port of the electrolyte pump such that the flow rate of electrolyte into the electrolytic cell is determined by the flow rate of the electrolyte pump, and having an oxidant output port, and accepting electrical energy from a source of electrical energy; and
(c) a control system, configured to control the electrolyte pump responsive to the amperage of electrical energy consumed by the electrolytic cell such that the oxidant concentration of the oxidant exiting the electrolytic cell is maintained between predetermined upper and lower bounds, wherein the control system controls the electrolyte pump to increase the flow rate of the electrolyte pump when the amperage of electrical energy consumed by the electrolytic cell increases.

2. The apparatus of claim 1, wherein the electrolyte pump comprises a positive displacement pump.

3. The apparatus of claim 1, wherein the electrolyte pump comprises a peristaltic pump.

4. The apparatus of claim 1, wherein the control system controls the electrolyte pump to decrease the flow rate of the electrolyte pump when the amperage of electrical energy consumed by the electrolytic cell decreases.

5. The apparatus of claim 1, wherein the control system comprises a programmed digital controller.

6. The apparatus of claim 1, wherein the control system comprises an electronic circuit.

7. The apparatus of claim 1, wherein the input port of the electrolytic cell is connected to the output port of the electrolyte pump without an intervening mixing cell.

8. The apparatus of claim 1, wherein the voltage across the electrolytic cell is constant.

9. An apparatus for the production of disinfectant, comprising
(a) an electrolyte pump, having an input port and an output port;
(b) an electrolyte reservoir, in fluid communication with the input port of the electrolyte pump;
(c) an electrolytic cell, in fluid communication with the electrolyte pump such that the flow rate of electrolyte into the electrolytic cell is determined by the flow rate of the electrolyte pump, and having a disinfectant output port;
(d) a disinfectant reservoir, in fluid communication with the disinfectant output port;
(e) a power monitor that produces a signal representative of power consumed by the electrolytic cell; and
(f) a control system that controls the flow rate of the electrolyte pump responsive to the signal, wherein the control system provides for an electrolyte pump flow rate that increases with increasing power consumed by the electrolytic cell.

10. The apparatus of claim 9, wherein the power monitor produces a signal representative of electrical current into the electrolytic cell.

11. The apparatus of claim 9, wherein the electrolytic cell is in fluid communication with the output port of the electrolyte pump.

12. The apparatus of claim 9, wherein the electrolytic cell is in fluid communication with the electrolyte reservoir and the electrolyte pump such that fluid from the electrolyte reservoir passes through the electrolytic cell before reaching the input port of the electrolyte pump.

13. The apparatus of claim 9, wherein the control system provides for an electrolyte pump flow rate that decreases with decreasing power consumed by the electrolytic cell.
